(19) United States
(12) Patent Application Publication
(10) Pub. No.: US 2008/0012682 A1
(43) Pub. Date: Jan. 17, 2008

(54) Wireless controller for monitoring device

(75) Inventors: Bernd Kagerer, Leverkusen (DE); Christian Lilienthal, Koln (DE)

Correspondence Address: MATHEWS, SHEPHERD, MCKAY, & BRUNEAU, P.A., 29 THANET ROAD, SUITE 201, PRINCETON, NJ, 08540, US

(73) Assignee: FRABA AG, Koln (DE)

(21) Appl. No.: 11/703,053

(22) Filed: Feb. 6, 2007

(30) Foreign Application Priority Data
Feb. 6, 2006 (DE) 102006005578.0-26

(51) Int. Cl. G05B 23/02

(52) U.S. Cl. 340/3.1

(57) ABSTRACT

A monitoring device and method for monitoring machine movements, moving parts of machines, gates, doors and the like, includes controller means with at least a first receiver for wirelessly receiving monitoring signals and a first transmitter for wirelessly transmitting activation signals, and includes monitoring means with at least a second receiver for receiving the activation signals, a second transmitter for transmitting monitoring signals, and at least one monitoring sensor for monitoring an unwired signal path. In one embodiment, the monitoring sensor is an optical safety shut-off bar that monitors the transmission of transmission signals via the unwired signal path. The monitoring device enables a high level of reliability in terms of obstacle detection and monitoring means failure, while keeping equipment outlay low, which is achieved by the monitoring means (U) wirelessly transmitting the monitoring signals (B) used by the monitoring sensor for monitoring the unwired signal path directly via the second transmitter (9) of the monitoring means (U) to the first receiver (3) of the control means. The control means (S) can transmit the monitoring signal (B) as a control signal to a control unit (1).

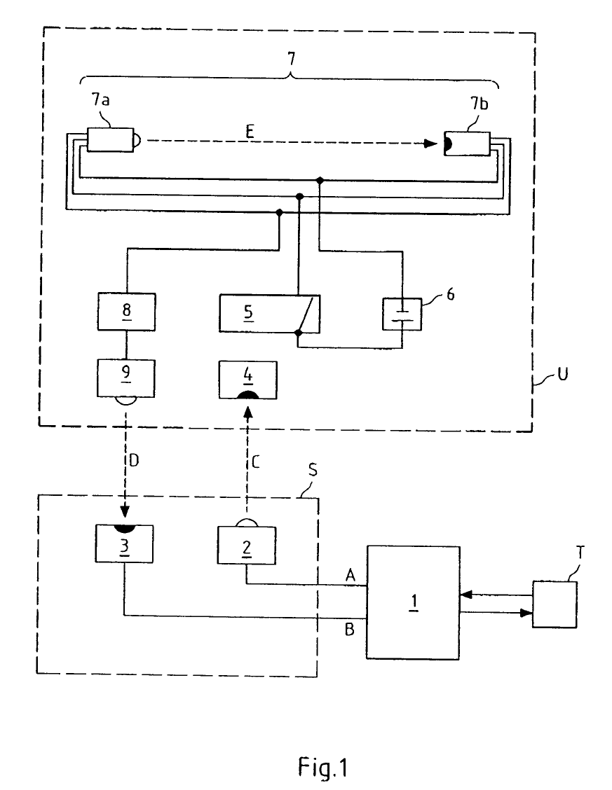

### FIELD OF THE INVENTION

The invention relates to a monitoring device for monitoring machine movements, moving parts of machines, gates, doors and the like, controlling generic monitoring devices, as well as to applications of the monitoring devices.

### BACKGROUND OF THE INVENTION

Monitoring devices are frequently used in places where a passage, driveway or other safety-relevant area must be monitored with monitoring means, e.g., to prevent dangers posed by moving machine parts, automatic doors or gates. For example, corresponding monitoring devices are used in automatically closing or motor-driven industrial gates. Optical monitoring sensors, e.g., an optical safety shut-off bar, are often used for monitoring, include a transmitter and receiver for transmitting and receiving optical monitoring signals, and monitor for an interruption in the signal path. If the signal path is interrupted, e.g., an arising obstacle interrupts an optical safety shut-off bar, the monitoring device typically sends a control signal, e.g., to a gate controller, which immediately stops the gate from moving. In order to detect obstacles in the area of moving parts in machines, doors or gates, the monitoring means of the monitoring devices are often secured to the moving areas themselves, thereby complicating power supply to the monitoring means. Wired systems, e.g., spiral cables, trailing cables or sliding contacts, have previously been used to supply power and, if needed, to transmit signals. However, the latter are high-maintenance, and generally disrupt the overall appearance of a machine or gate. A great deal of effort previously focused on making battery-assisted monitoring means efficient in the detection of malfunctions. However, as a result of these efforts, the batteries utilized do not have a long enough service life, especially in view of the small dimensions of the batteries to be used.

One especially important aspect with respect to monitoring devices is their fail-safe. For example, a failure of the monitoring means for an automatically moving gate must prevent the gate from moving any longer so as to basically preclude dangers. The monitoring means themselves must therefore be monitored for potential failures. Known from International Patent Application WO 03/069352 is a monitoring device with battery-assisted monitoring means, which uses coded signals for the optical or radio transmission of information about the functional state of the monitoring means to the control means. The microprocessor of the monitoring means that generates the coded signal is switched to a sleep mode between transmissions to reduce power consumption. On the one hand, the effort (i.e., power consumption) related to the appliance is quite high, in particular for monitoring the functional state of these monitoring devices. On the other hand, the known monitoring device consumes power regardless of the actual time for which the monitoring device operates, since the functional state of the monitoring means is permanently interrogated.

### SUMMARY OF THE INVENTION

Proceeding from this state of the art, an object of this invention is to provide a generic monitoring device and a method for controlling a generic monitoring device that enables a high level of reliability in terms of obstacle detection and monitoring means failure, while keeping the effort (i.e., power consumption) for the appliance low. At the same time, the service life of autonomous voltage sources for the monitoring means is to be increased. Further, an object of the invention is to propose advantageous applications of the monitoring device according to the invention.

A monitoring device is provided having controller means with at least one control unit, a first receiver for wirelessly receiving monitoring signals and a first transmitter for wirelessly transmitting activation signals. The monitoring device also includes monitoring means with at least a second receiver for receiving the activation signals, a second transmitter for transmitting monitoring signals, and at least one monitoring sensor for monitoring an unwired signal path, in particular an optical safety shut-off bar, wherein the monitoring sensor monitors the transmission of transmission signals via the unwired signal path.

According to a first teaching of the present invention, the derived object is solved by a generic monitoring device by virtue of the fact that the monitoring means is able to wirelessly transmit the monitoring signal used by the monitoring sensor for monitoring the unwired signal path directly via the second transmitter of the monitoring means to the first receiver of the control means and the control means are able to transmit the monitoring signal as a control signal to a control unit.

Since the monitoring signal of the monitoring sensor is directly transmitted to a control unit (i.e., without changing the modulation frequency of the signal), a fault in the monitoring device or an obstacle can be easily detected by a control unit if this monitoring signal is not received, which causes a gate drive to immediately stop gate movement, for example. In the framework of this invention, direct transmissibility is interpreted to mean a transmission that does not alter the signal frequency of the monitoring signal itself. For example, a change in the duty-cycle of the monitoring signal does not cause a change in its frequency. Wireless signal transmission usually takes place by modulating a higher carrier frequency with the monitoring signal. The frequency of the monitoring signal itself is not changed here either. It was surprisingly found that the monitoring signals of the monitoring sensors, which exhibit a high level of reliability in detecting obstacles in the form of disturbances, e.g., by interference signals, can also be used for wirelessly transmitting the state information of the monitoring sensor to the control means. This results directly in a wireless transmission of state information to the control means that is less sensitive to disturbances. This makes it possible to detect even with a simple equipment design a disturbance in the monitoring means and also an obstacle. At the same time, high safety requirements are also satisfied. Since the failure to receive the monitoring signal of the monitoring sensor can simultaneously signal the failure of the monitoring sensor itself or an interruption in the monitored signal path, (i.e., the presence of an obstacle), it is possible to forego a complex encoding of the monitoring signal of the monitoring sensor. Nonetheless, an alternative embodiment may utilize monitoring signals encoded by the monitoring sensor according to a protocol to monitor the signal path, and transmit these signals to the control means.

If the monitoring signal is able to transmitted with an altered duty-cycle, in particular with a duty-cycle of 1:5 to 1:20, preferably 1:8 to 1:12, in the monitoring device configured with the transmitter of the monitoring means, the power consumption of the monitoring means can be reduced without impairing transmission reliability. Optimal results relative to transmission reliability and complexity of transmitter and receiver were achieved at a duty-cycle of about 1:10.

The control means can be used to easily detect whether the monitoring sensor has detected a control signal-triggering event, because monitoring means only transmit a monitoring signal to the control means if the signal path of the monitoring sensor is faultless. As soon as the signal path of the monitoring sensor is interrupted, no monitoring signal is hence transmitted to the monitoring means, and the control unit can generate a corresponding control signal, e.g., to stop the drive of an automatic gate or other machine. The machines or gates can utilize the control signal directly for control purposes, or relay it to the input of another controller.

In order to generate the monitoring signals, the monitoring sensor preferably has at least one oscillating circuit with at least one time-delay element or a frequency generator, in particular a microprocessor, so that a monitoring signal with a specific frequency is generated with a low effort related to the appliance when the monitoring sensor is activated. This signal can be directly transmitted to the control means with the monitoring device according to the invention.

In another advantageous embodiment of the monitoring device according to the invention, the monitoring means include an autonomous voltage source, in particular a battery and/or an accumulator. Since the monitoring means are usually movably situated relative to the control means, the already mentioned low power consumption combined with the simple structural design of the monitoring device according to the invention and its monitoring means make possible a simple voltage source comprised of a battery or accumulator. Also possible is the use of a rechargeable capacitor, provided the latter exhibits a high enough charging capacity.

A charger is preferably provided for charging the autonomous voltage source, so that the latter can always be automatically charged when the monitoring means are situated in a specific position, thereby extending maintenance intervals.

The power consumption of the monitoring device according to the invention can also be further decreased by making it possible to activate or deactivate the voltage source of the monitoring means depending on whether the activation signal is received at the second receiver. Deactivating the voltage source, e.g., if the monitoring means are not used, permits a tangible reduction in the power consumption of the monitoring means, thereby significantly increasing the service life of the battery or accumulator.

In another advantageous further developed embodiment of the monitoring device according to the invention, the voltage source is able to be activated only during an event that requires monitoring by the monitoring means. The monitoring means are switched to no load until an event that requires monitoring takes place, e.g., the movement of a machine part or gate. If the gate or machine with the monitoring means is moved, the voltage source is activated. As a result, the monitoring means are merely activated at times when actually needed. This yields a further reduction in the power consumption of the monitoring means.

Power consumption is also reduced by the fact that optical transmitters and receives are provided as the first and second transmitter and receiver. Providing essentially identically designed optical transmitters and optical receivers as the first and second transmitter and receiver also further lowers the effort of appliance of the monitoring device according to the invention.

In another further developed embodiment of the monitoring device according to the invention, a first wireless transmission path is provided for receiving the monitoring signals via the first receiver, and a second wireless transmission path is provided for transmitting the activation signals via the first transmitter, and both transmission paths are decoupled. In terms of this invention, a transmission path involves the transmission of transmission signals over a specific carrier frequency. Transmission is also mostly modulated even for optical receivers and transmitters to ensure insusceptibility to the influence of external light.

The fault susceptibility of the monitoring device according to the invention is preferably lowered even further in that the signals transmitted on the first and second transmission path and optionally on the signal path of the monitoring sensor exhibit different carrier frequencies. As a result, none of the transmission paths is able to influence the other, since the respective transmitter and receiver only detect signals with the corresponding carrier frequency.

According to another teaching of this invention, it is particularly advantageous to use a monitoring device according to the invention for detecting an obstacle, in particular in the traveling path of machines, moving parts of machines, doors, gates and the like, since the latter satisfies maximum safety requirements at a low technical effort of appliance, and can simultaneously operate on batteries due to the low power consumption. The wireless transmission of monitoring signals eliminates the need for an expensive cabling of the machines or machine parts, gates or doors. The monitoring means do not necessarily have to be arranged on the moving parts, e.g., of machines, when using the monitoring device according to the invention. Rather, it may also be advantageous to have the monitoring means be stationary for detecting moving machine parts.

According to a further teaching of this invention, the object described above is achieved by a method for controlling a generic monitoring device by virtue of the fact that the monitoring signals generated by the monitoring sensor are wirelessly transmitted directly to the first receiver of the control means via the second transmitter, and the monitoring signals are transmitted from the control means to a control unit as control signals. According to the invention, then, the same signals utilized to monitor a signal path are transmitted directly to the control means, so that a lower susceptibility to disturbances can be ensured in terms of the reception of the monitoring signal by the first receiver of the control means on the one hand, and the effort of appliance is kept to a minimum on the other, since a complex encoding of the monitoring signals for transmitting the functional state is not required.

The power consumption of the monitoring means can also be reduced by having the transmitter of the transmission means transmit a monitoring signal with an altered duty-cycle, in particular a duty-cycle of 1:5 to 1:20, preferably 1:8 to 1:12. The duty-cycle of the monitoring signal is advantageously reset again at the receiver, and relayed via a control means to a control unit, so that continued use can be made of conventional control units.

If the monitoring signal is continuously generated and transmitted to control means via the second transmitter given a faultless signal path of the monitoring sensor to be monitored, the control unit can, specifically if the control means do not receive the monitoring signal, easily recognize whether an obstacle has been detected or some other disturbance is present, requiring the generation of a corresponding control signal, e.g., for stopping the system.

The monitoring signal of the monitoring sensor is preferably generated by at least one oscillating circuit with at least one time-delay element or a frequency generator, in particular a microprocessor. The monitoring signals here typically have a modulation frequency of about 1 kHz. However, other modulation frequencies can be used, depending on the application.

A further developed embodiment of the method according to the invention for controlling a monitoring device reduces the power consumption of the monitoring means by only activating the voltage source of the monitoring means for the time that an event requires monitoring by means of the monitoring sensor. With the voltage source activated, the monitoring sensor then generates monitoring signals. The minimized on-times of the monitoring means, leads directly to an extremely low power consumption.

If an activation signal is transmitted to the second receiver for activating the voltage source only for the duration of the event that triggers monitoring, the monitoring sensor can be easily activated or deactivated depending of receipt of the activation signal. At the same time, this ensures a high level of functional reliability for the monitoring means. For example, if the transmission path to the second receiver that receives the activation signal of the voltage source has been interrupted by a fault, the voltage source is not activated, and the monitoring sensor does not generate a monitoring signal. The monitoring means are able to react to the absence of the monitoring signal by generating a corresponding control signal. If in the case of a received activation signal the transmission path between the monitoring means and the control means is interrupted it can easily detected by the control means.

If the transmission of the monitoring signals via the signal path of the monitoring sensor, and its transmission to the control means as well as the transmission of the activation signals to the monitoring means is carried out in an optical manner, sensors and receivers having essentially the same design can be used, thereby correspondingly simplifying the structure of the monitoring device according to the invention. In addition, optical transmission paths are especially easy to configure in such a way as to be mutually decoupled.

The various transmission paths are preferably decoupled by having the monitoring signal transmitted to the control means, the activation signal transmitted by the control means to the monitoring means and/or the monitoring signal of the signal path of the monitoring signal exhibit different carrier frequencies. The fact that the accompanying receivers of the respective transmission paths react selectively to the carrier frequencies minimizes mutual signal influence along with external light sensitivity.

There are numerous ways to configure and further develop the monitoring device according to the invention, and the method according to the invention for controlling a monitoring device.

To this end, reference is made on the one hand to the claims following claims 1 and 13, and on the other hand to the description of an exemplary embodiment in conjunction with the drawing.

### BRIEF DESCRIPTION OF THE DRAWING

The sole FIGURE in the drawings shows a schematic circuit diagram of an embodiment of a monitoring device according to the invention.

### DETAILED DESCRIPTION

The schematic circuit diagram of an embodiment first shows the control means S and the monitoring means U. The control means S includes a first transmitter 2 and a first receiver 3. The control unit 1, which is in contact with both the first transmitter 2 and the first receiver 3, can be connected directly with a gate drive T, a gate controller or a controller for another machine in such a way that the latter can both receive request signals for activating the monitoring process and relay control signals to the drive or controller. However, it is also possible for the control unit 1 to be supplied with request signals from another control unit, or generate the request signal itself. If the control unit 1 receives a corresponding request signal at the start of monitoring or generates the latter itself, e.g., by initiating a gate travel by the control unit 1, it generates an activation signal A. The activation signal A is used to activate the voltage source 6 of the monitoring means U.

The first transmitter 2 of the control means S transmits the activation signal A via the wireless transmission path C to a second receiver 4, which is part of the monitoring means. The latter are generally situated remote from the control means S, e.g., on moving machine parts, gates or doors. The transmitter 2 preferably transmits the activation signal A for as long as the monitoring request signal is transmitted by the control unit 1, e.g., for as long as a gate is in motion. In order to generate a constant transmission signal via the first transmitter 2, optional signal evaluation means (not shown) can be arranged between the control unit 1 and the transmitter 2, which generate a signal that remains constant over the time of the activation signal A of the control unit, which generally consists of a pulse. In this embodiment, however, a constant activation signal A that remains constant for the duration of the monitoring request is generated directly via the control unit 1, relayed to the control means S, and wirelessly transmitted to the monitoring means via the transmission path C by the first transmitter 2 of the control means S.

If the second receiver 4 now receives the activation signal A via the wireless transmission path C, a signal evaluation unit 5, which can include a relay, for example, starts or activates the voltage sources 6. The monitoring sensor 7, which monitors the signal path E with the aid of the transmitter 7a and receiver 7b, generates a monitoring signal, if the signal path E is faultless, which is preferably emitted by the transmitter 7a in the form of a rectangular-pulse signal with a frequency in the kilohertz range. As already described, the monitoring signal is preferably generated by at least one oscillating circuit (not shown in the drawing) having at least one time-delay element. The oscillating circuit may also encompass the signal path E, for example. In such an oscillating circuit, for example, the transmitter 7a of the monitoring sensor 7 starts to transmit a monitoring signal B over signal path E after activation of the voltage source 6. Once the receiver 7b of the monitoring sensor 7 has received the monitoring signal, it turns off the transmitter 7a, so that no monitoring signal is transmitted. As soon as the monitoring signal is no longer present at the receiver 7b, the latter reactivates the transmitter 7a, and so on.

A modulation frequency for the monitoring signal can be selected through the choice of time-delay element (not shown) and as a function of the signal path E. It typically measures about 1 kHz. As a rule, corresponding monitoring signals are additional modulated with a carrier frequency to make the monitoring signal unsusceptible to disturbances by outside signals, e.g., ambient light. These carrier frequencies measure around 38 kHz for optical transmitters and receivers. Other carrier frequencies can also be used, however. The monitoring signal used by the monitoring sensor is relayed directly to the second transmitter 9 via a signal evaluation unit 8. The second transmitter 9 transmits the signal via the transmission path D to the first receiver 3, which relays the monitoring signal B to the control unit 1. Before transmission of the monitoring signal B, its duty-cycle is preferably modified to reduce the power consumption of the monitoring means. The duty-cycle can be changed both in the transmitter 9 and in the evaluation unit 8. The duty-cycle may range from 1:5 to 1:20, preferably from 1:8 to 1:12, especially preferred 1:10, in order to achieve a significant reduction in power consumption.

The signal evaluation unit 8 is only used to modulate the monitoring signal in the low kilohertz range with a carrier frequency, e.g., 56 kHz, other than that for the signal path E in order to decouple the transmission paths D, C and the signal path E. The transmitter and receiver 2, 3, 4, 7a, 7b, 9 are preferably optical transmitters and receivers. The circuit effort can be minimized further, since the signals need not be transformed or modulated for each different transmission path. In addition, corresponding optical transmitters and receivers are also characterized by extremely low power consumption.

As already described above, the monitoring device activates the monitoring means U only at times that require monitoring of the signal path E, e.g., for detecting an obstacle. This already results in a very low power consumption for the monitoring means, and an extremely long service life for the autonomous power source 6. In the present embodiment, the control unit 1 of a gate only sends the activation signal A to the control means S if a monitoring signal 8 is present, which then transmits the latter to the monitoring means U via the transmission path C. At the same time, the gate drive T or another controller is prompted to further move the gate or machine if a monitoring signal B is present. The monitoring device hence ensures a high level of safety. As soon as one of the transmission paths C, D, E fails, e.g., due to the malfunction of the monitoring sensor 7, a transmitter 2, 9, 7a or a receiver 3, 4, 7b of the transmission paths C, D and the signal path E, the control unit 1 no longer receives the monitoring signal B, so that the control unit 1 can generate a control signal, e.g., which stops the gate drive T. Directly using the monitoring signals of the monitoring sensor 7 for communicating with the control means also imparts the high interference resistance known for the monitoring sensors 7, e.g., optical safety shut-off bars, to the communication between control means S and monitoring means U. With very simple means it is possible to provide a high level of fault tolerance and simultaneously a reliable monitoring of the movement of moving parts in conjunction with a low power consumption.

1. A monitoring device for monitoring machine movements, moving parts of machines, doors, gates and the like, the monitoring device comprising
control means (S) having
at least a first receiver (3) for wirelessly receiving a monitoring signal, and
at least a first transmitter (2) for wirelessly transmitting an activation signal, and
monitoring means (U) having
at least a second receiver (4) for receiving the activation signal,
a second transmitter (9) for transmitting the monitoring signal, and
at least one monitoring sensor (7) for monitoring an unwired signal path (E),
wherein the monitoring sensor (7) monitors the transmission of the monitoring signal (B) via the unwired signal path (E), and wherein the monitoring means (U) is operative to wirelessly transmit the monitoring signal (B) used by the monitoring sensor for monitoring the unwired signal path directly via the second transmitter (9) of the monitoring means (U) to the first receiver (3) of the control means (S), and the control means (S) is operative to transmit the monitoring signal (B) as a control signal to a control unit (1).

2. The monitoring device according to claim 1, wherein the transmitter (9) of the monitoring means is operative to transmit the monitoring signal at an altered duty-cycle.

3. The monitoring device according to claim 1 or 2, wherein the monitoring sensor (7) has at least one oscillating circuit with at least one time-delay element or a frequency generator that generates the monitoring signal.

4. The monitoring device according to claim 1 wherein the monitoring means (U) only transmits the monitoring signal to the control means (S) given a faultless signal path (E).

5. The monitoring device according to claim 1 wherein the monitoring means (U) includes at least one of an autonomous voltage source (6), a battery or an accumulator.

6. The monitoring device according to claim 5 further including a charger for charging the voltage source (6).

7. The monitoring device according to claim 5 wherein the voltage source (6) of the monitoring means is able operative to be activated or deactivated depending on the reception of the activation signal (A) at the second receiver (4).

8. The monitoring device according claim 5 wherein the voltage source (6) is operative to be activated only during an event that requires monitoring by the monitoring means (U).

9. The monitoring device according to claim 1 wherein the first and second transmitters (2, 9) are optical transmitters and the first and second receivers (3, 4) are optical receivers.

10. The monitoring device according to claim 1 wherein a first wireless transmission path (D) is provided for receiving the monitoring signal via the first receiver (3), and a second wireless transmission path (C) is provided for transmitting the activation signal (A) via the first transmitter (2), and both transmission paths (C, D) are decoupled.

11. The monitoring device according to claim 10 wherein signals transmitted on the first wireless transmission path and the second wireless transmission path (D, C) exhibit different carrier frequencies.

12. A method of using a monitoring device according to claim 1 to detect an obstacle in the traveling path of machines, moving parts of machines, doors, gates and the like.

13. A method for controlling a monitoring device, wherein the monitoring device includes
control means having at least a first receiver for wirelessly receiving a monitoring signal and at least a first transmitter for wirelessly transmitting an activation signal, and
monitoring means having at least a second receiver for receiving the activation signal, a second transmitter for transmitting the monitoring signal, and at least one monitoring sensor for monitoring an unwired signal path, the method comprising;
monitoring with the monitoring sensor the transmission of the monitoring signal via the unwired signal path,
wirelessly transmitting the monitoring signal generated by the monitoring sensor directly via the second transmitter to the first receiver of the control means, and
transmitting the monitoring signal by the control means as a control signal to a control unit.

14. The method according to claim 13, wherein the transmitter of the monitoring means transmits the monitoring signal at an altered duty-cycle.

15. The method according to claim 13 wherein the monitoring sensor continuously generates the monitoring signal given a faultless signal path monitored by the monitoring sensor, and transmits the monitoring signal to the control means via the second transmitter.

16. The method according claim 13 wherein the monitoring signal of the monitoring sensor is generated by at least one oscillating circuit having at least one time-delay element or a frequency generator.

17. The method according to claim 13 wherein a voltage source of the monitoring means is only activated for the time that an event requires monitoring by means of the monitoring sensor.

18. The method according to claim 13 wherein the activation signal is only transmitted for the duration of the event that triggers monitoring.

19. The method according to claim 13 wherein the transmission of the monitoring signals via the signal path and to the control means as well as the transmission of the activation signal is carried out in an optical manner.

20. The method according to claim 13 wherein at least one of the monitoring signal transmitted to the control means, the activation signal transmitted by the control means to the monitoring means, and the monitoring signal of the signal path of the monitoring sensor exhibit different carrier frequencies.

21. The monitoring device according to claim 1 wherein the monitoring sensor for monitoring the unwired signal path is an optical safety shut-off bar.

22. The monitoring device according to claim 2 wherein the transmitter of the monitoring means is operative to transmit the monitoring signal at a duty-cycle ranging from approximately 1:5 to 1:20.

23. The monitoring device according to claim 1 wherein the monitoring sensor has a microprocessor that generates the monitoring signal.

24. The monitoring device according to claim 9 wherein identically designed receivers are provided as the first receiver and the second receiver and identically designed transmitters are provided as the first transmitter and second transmitter.

25. The monitoring device according to claim 11 wherein signals transmitted on the first wireless transmission path, the second wireless transmission path and the unwired signal path (E) of the monitoring sensor exhibit different carrier frequencies.

26. The method according to claim 13 wherein the monitoring sensor for monitoring the unwired signal path is an optical safety shut-off bar.
